(19) United States
(12) Patent Application Publication
(10) Pub. No.: US 2026/0252531 A1
(43) Pub. Date: Aug. 27, 2026

(54) TECHNIQUES FOR IMPROVING SCANNING EFFICIENCY VIA IDENTIFICATION OF DUPLICATED FOLDERS

(71) Applicant: Cyera, Ltd., Tel Aviv (IL)

(72) Inventors: Ella SEVER, Tel Aviv (IL); Michal SHAKED, Ramat Gan (IL); Doron PORATH, Tel Aviv (IL); Yoav KIMCHI, Tel Aviv (IL); Eyal ERLICH, Modi’in (IL); Yotam SEGEV, New York, NY (US); Itamar BAR-ILAN, New York, NY (US); Yonatan ITAI, Tel Aviv (IL)

(73) Assignee: Cyera, Ltd., Tel Aviv (IL)

(21) Appl. No.: 19/095,506

(22) Filed: Mar. 31, 2025

Related U.S. Application Data
(60) Provisional application No. 63/762,398, filed on Feb. 24, 2025.

(51) Int. Cl. G06F 16/174; G06F 16/16

(52) U.S. Cl. CPC G06F 16/1748; G06F 16/16

(57) ABSTRACT

A system and method for scanning. In a name comparison, a name of at least one inner folder within a first folder is compared to names of second folders in order to identify a name-matching second folder among the second folders, where the name of the matching second folder matches the name of a first inner folder among the inner folders within the first folder. In an object comparison, objects of the first inner folder within the first folder are compared to objects of the name-matching second folder in order to determine that the objects of the first inner folder match the objects of the name-matching second folder. A duplicated folder is identified based on the name comparison and the object comparison. In a version of the process exactly one of the first folder and the name-matching second folder is scanned when the duplicated folder is identified.

### CROSS-REFERENCE TO RELATED APPLICATIONS

This application claims the benefit of U.S. Provisional Application No. 63/762,398 filed on Feb. 24, 2025, the contents of which are hereby incorporated by reference.

### TECHNICAL FIELD

The present disclosure relates generally to data scanning, and more specifically to improving scanning efficiency.

### BACKGROUND

With the large amount of data being stored in modern organizations, securing that data becomes increasingly challenging. A principle of data security is that what is unknown is difficult or impossible to properly protect. To this end, data scanning techniques are used in order to scour computing environments for potential data to be protected. Due to the large number of computing resources which may be consumed by such scanning, techniques which reduce the amount of data which needs to be scanned in order to effectively protect computing environments are highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for scanning. The method comprises: comparing, in a name comparison, a name of at least one inner folder within a first folder to a plurality of names of a plurality of second folders in order to identify a name-matching second folder of the plurality of second folders, wherein the name of the matching second folder matches the name of a first inner folder of the at least one inner folder within the first folder; comparing, in an object comparison, a plurality of objects of the first inner folder within the first folder to a plurality of objects of the name-matching second folder in order to determine that the plurality of objects of the first inner folder match the plurality of objects of the name-matching second folder; identifying a duplicated folder based on the name comparison and the object comparison; and scanning only one of the first folder and the name-matching second folder when the duplicated folder is identified.

Certain embodiments disclosed herein also include a non-transitory computer-readable medium having stored thereon causing a processing circuitry to execute a process, the process comprising: comparing, in a name comparison, a name of at least one inner folder within a first folder to a plurality of names of a plurality of second folders in order to identify a name-matching second folder of the plurality of second folders, wherein the name of the matching second folder matches the name of a first inner folder of the at least one inner folder within the first folder; comparing, in an object comparison, a plurality of objects of the first inner folder within the first folder to a plurality of objects of the name-matching second folder in order to determine that the plurality of objects of the first inner folder match the plurality of objects of the name-matching second folder; identifying a duplicated folder based on the name comparison and the object comparison; and scanning only one of the first folder and the name-matching second folder when the duplicated folder is identified.

Certain embodiments disclosed herein also include a system for scanning. The system comprises: a processing circuitry; and a memory, the memory containing instructions that, when executed by the processing circuitry, configure the system to: compare, in a name comparison, a name of at least one inner folder within a first folder to a plurality of names of a plurality of second folders in order to identify a name-matching second folder of the plurality of second folders, wherein the name of the matching second folder matches the name of a first inner folder of the at least one inner folder within the first folder; compare, in an object comparison, a plurality of objects of the first inner folder within the first folder to a plurality of objects of the name-matching second folder in order to determine that the plurality of objects of the first inner folder match the plurality of objects of the name-matching second folder; identify a duplicated folder based on the name comparison and the object comparison; and scan only one of the first folder and the name-matching second folder when the duplicated folder is identified.

Certain embodiments disclosed herein include a method, non-transitory computer-readable medium, or system as noted above or below, further including or being configured to perform the following step or steps: determining that a number of comparisons between the plurality of objects of the first inner folder and the plurality of objects of the name-matching second folder reaches a threshold, wherein the duplicated folder is identified based further on the determination that the number of comparisons between the plurality of objects of the first inner folder and the plurality of objects of the name-matching second folder reaches the threshold.

Certain embodiments disclosed herein include a method, non-transitory computer-readable medium, or system as noted above or below, further including or being configured to perform the following step or steps: recursively identifying objects among the plurality of objects of the first inner folder and among the plurality of objects of the name-matching second folder and comparing the recursively identified objects between the first inner folder and the name-matching second folder until a total number of comparisons of objects between the first inner folder and the name-matching second folder reaches the threshold, wherein it is determined that the number of comparisons between the plurality of objects of the first inner folder and the plurality of objects of the name-matching second folder reaches the threshold when the total number of comparisons between the first inner folder and the name-matching second folder reaches the threshold.

Certain embodiments disclosed herein include a method, non-transitory computer-readable medium, or system as noted above or below, further including or being configured to perform the following step or steps: running a listing command on each of the first inner folder and the name-matching second folder, wherein the listing command run on a folder returns a list of objects of the folder, wherein the plurality of objects of the first inner folder is based on results of running the listing command on the first inner folder, wherein the plurality of objects of the name-matching second folder is based on results of running the listing command on the name-matching second folder.

Certain embodiments disclosed herein include a method, non-transitory computer-readable medium, or system as noted above or below, wherein the first folder is encountered during scanning of a computing environment, wherein the scanning of the computing environment is paused until the first folder or the name-matching second folder has been scanned, wherein the scanning of the computing environment resumes when the first folder or the name-matching second folder has been scanned.

Certain embodiments disclosed herein include a method, non-transitory computer-readable medium, or system as noted above or below, wherein the plurality of objects of the first inner folder and the plurality of objects of the name-matching second folder include files.

Certain embodiments disclosed herein include a method, non-transitory computer-readable medium, or system as noted above or below, wherein the object comparison is performed when the name-matching second folder has been identified based on the name comparison.

Certain embodiments disclosed herein include a method, non-transitory computer-readable medium, or system as noted above or below, wherein the duplicated folder is identified as the name-matching second folder, wherein the name-matching second folder resides in the first folder.

Certain embodiments disclosed herein include a method, non-transitory computer-readable medium, or system as noted above or below, wherein the first folder and each of the plurality of second folders is a shared folder, wherein the identified duplicated folder is a nested share which resides in the first folder.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for scanning according to an embodiment.

FIG. 3 is a flowchart illustrating a method for avoiding duplicate scanning based on duplicated folders according to an embodiment.

FIG. 4 is a schematic diagram of a scanner according to an embodiment.

### DETAILED DESCRIPTION

The various disclosed embodiments include a method and system for improved efficiency scanning based on duplicated folders such as, but not limited to, nested shares or other folders containing contents which are duplicates of contents of other folders. Various disclosed embodiments provide techniques for identifying duplicated folders and for using such identifications of duplicated folders to avoid duplicate scanning. More specifically, in accordance with various disclosed embodiments, when a duplicated folder is identified, the duplicated folder may be scanned and portions of data to avoid scanning may be determined based on the identified duplicated folder. As a non-limiting example, an identified duplicated folder may be scanned, and a parent folder of the duplicated folder may be determined as a portion of data to avoid scanning.

Identifying duplicated folders and avoiding scanning portions of data based on those duplicated folders may allow, for example, avoiding duplicate scanning (for example, scanning objects of a duplicated folder as well as the same objects in a parent folder of the duplicated folder), scan only select portions of data (for example, scanning only a duplicated folder rather than a parent folder of the duplicated folder), both, and the like. The result is that avoiding scanning portions of data in this manner allows for reducing the total amount of data to be scanned, thereby conserving computing resources.

To this end, in an embodiment, one or more checking phases may be utilized in order to identify potential duplicated folders. For example, when a new folder is encountered during scanning, checks may be performed in one or more of these checking phases in order to determine if the folder is or has a duplicated folder. To this end, any or all of the following checking phases may be utilized in accordance with various disclosed embodiments.

In a first name-based checking phase, it is checked whether a name of a folder matches the name of any other folders in a given computing environment or portion thereof (for example, in a given filesystem). If the folder name matches another folder name, execution may proceed with a subsequent checking phase; otherwise, the folder may be scanned and scanning may continue as normal until the next folder is found.

In a second content-based checking phase, for any folders whose name matches the folder, contents of the folders may be compared. To this end, a listing command may be run on such folders in order to identify objects in each folder. In an embodiment, comparing the contents between folders of a given pair of folders includes comparing objects between the folders to determine whether the folders include the same objects. For example, results of listing commands run on each folder may be compared to determine if the folders contain the same objects. If the folders contain the same objects, the pair of folders may be identified as including a duplicated folder or potentially including a duplicated folder. If there are any mismatches (for example, objects in one folder which are not in the other folder), then neither of the folders may be identified as a duplicated folder of the other and scanning may proceed accordingly.

In a third confidence checking phase, each pair of folders identified as potentially including a duplicated folder may be subject to one or more additional checks to improve the confidence that one of the folders is a duplicated folder of the other. In an embodiment, the third confidence checking phase includes determining how many objects were compared between the folders (for example, based on how many objects were included in the results of the listing command run on each folder). In some embodiments, a given pair of folders is identified as including a duplicated folder when the number of objects compared between the folders is above a predetermined threshold (for example, a threshold of 3 objects or 5 objects). In this regard, it has been identified that pairs of folders with very few objects in common (as a non-limiting example, only 1 or 2 objects) may appear to include duplicated folders, but that a small number of objects may not accurately reflect whether one of the folders is actually a duplicated folder of the other. By using a minimum threshold of objects, the confidence that one folder is a duplicated folder of another folder may be increased, thereby allowing for more accurately identifying duplicated folders.

In this regard, it is noted that a duplicated folder is a folder which resides in another folder and contains duplicated contents. The other folder in which a duplicated folder resides is the parent folder of that folder. The duplicated contents may include, but are not limited to, objects. The duplicated contents are contents which are the same and appear in both the parent folder and the duplicated folder of that parent folder. Because the duplicated folder is effectively a subfolder containing a subset of the data (for example objects) in the parent folder, scanning both the duplicated folder and the parent folder can result in duplicate scanning (for example, scanning the same objects twice).

For nested shares, a nested share is a shared folder which resides in another shared folder. The parent folder of a nested share may be referred to as a parent share or parent folder. Both the nested share and the parent share may be independently shared with different users, and may be assigned different permissions (for example, different file sharing permissions). It has also been identified that filesystems typically use the same name for a nested share and for the parent share by default, and that, while it is possible to change the name of the nested share to a different name of the parent share, users do not typically make this change such that the names remain the same. Various disclosed embodiments utilize this finding in order to reduce the amount of scanning by checking for duplicate names as a starting point for identifying duplicated folders which may contain redundant data such as nested shares.

To this end, it has been identified that determining whether a folder is a nested share or otherwise whether the folder is a duplicated folder may allow for avoiding this duplicate scanning. Additionally, in at least some implementations, it may only be relevant to scan the contents (for example, objects) of the duplicated folder, and scanning the entire contents of the parent folder of that duplicated folder may therefore be unnecessary. Accordingly, the disclosed embodiments allow for reducing the amount of data to be scanned in filesystems by avoiding duplicate scanning of the same object, scanning only nested shares within parent folders, or both. Further, reducing the number of folders or otherwise reducing the number of objects to be scanned allows for making fewer requests when performing on-premises scanning via a remote system (for example, a scanner deployed outside of a computing environment being scanned). This reduces number of requests allows for reducing consumption of network resources as well as load and demand on servers handling requests within the computing environment, thereby further conserving computing resources.

Moreover, identifying or removing duplicated folders allows for providing a more accurate view of a computing environment. That is, by removing duplicated folders, only folders which are unique may be presented. This, in turn, allows for illustrating the contents of the computing environment more accurately, for example by more accurately illustrating the total amount of unique data in the computing environment. For nested shares, the nested shares may be avoided when presenting data about the computing environment so as not to present the nested shares (which may be temporary or may otherwise only be used for limited purposes or time) as part of the computing environment to be tracked longer term.

Also, it has further been identified that certain admin permissions may allow for enumerating shares, which in turn can be used to identify nested shares. However, on-premises scans may be performed by external entities which lack admin permissions for a given computing environment. The disclosed embodiments may be utilized to identify nested shares or other duplicated folders without requiring admin permissions or otherwise requiring fewer admin permissions than solutions which would leverage admin permissions in order to identify shares through direct enumeration. Similarly, the disclosed embodiments may be performed without requiring full access to primitives used within a given computing environment. Accordingly, the disclosed embodiments may help enable third party service providers such as cybersecurity service providers to efficiently but comprehensively perform on-premises scans of computing environments without requiring full admin permissions.

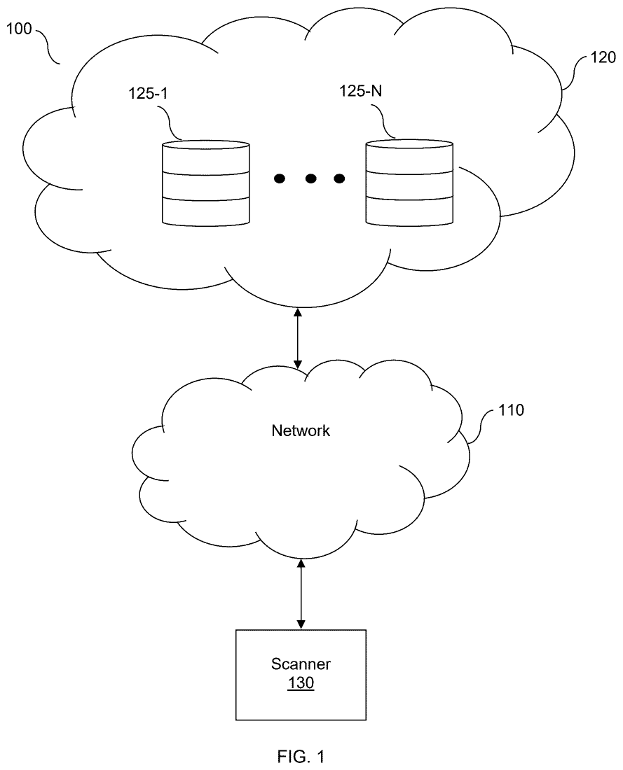

FIG. 1 shows an example network diagram 100 utilized to describe the various disclosed embodiments. In the example network diagram 100, a computing environment 120 and a scanner 130 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The computing environment 120 includes disks 125-1 through 125-N, where N is an integer having a value of 1 or greater (hereinafter referred to individually as a disk 125 and collectively as disks 125). The disks 125 may contain one or more databases (DBs, not shown) or otherwise may store data which, in accordance with various disclosed embodiments, may be desired to scan. The disks 125 may be or may include physical disks, virtual disks, or both.

The data in the disks 125 may be organized via one or more hierarchies such as, but not limited to, filesystems folders and subfolders. Any of the data in the disks 125 may be shared with other systems (not shown) using shares, and those shares may include at least some shares which are nested within other parent shares.

The scanner 130 is configured to scan data in the computing environment 120 as described herein. Such scanning may include, but is not limited to, server message block (SMB) scans using the SMB protocol. To this end, the scanner 130 may be configured to recursively run listing commands in order to recursively run SMB scans, or otherwise to scan in order to identify folders and other data within the disks 125 or otherwise within the computing environment 120.

In accordance with various disclosed embodiments, folders encountered during scanning may be checked for potential duplicated folders, and identifications of duplicated folders may be utilized to determine how to proceed with scanning. For example, duplicated folders identified by checking may be scanned instead of their respective parent folders (i.e., a parent folder in which each duplicated folder resides) in order to avoid redundant scanning or otherwise reduce the total amount of data to be scanned.

It should be noted that FIG. 1 depicts an implementation of various disclosed embodiments, but that at least some disclosed embodiments are not necessarily limited as such. Other deployments, arrangements, combinations, and the like, may be equally utilized without departing from the scope of the disclosure.

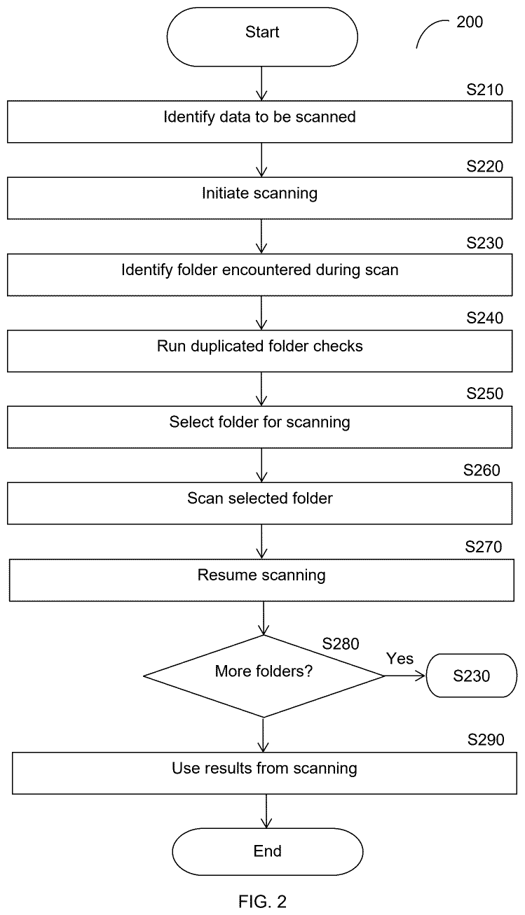

FIG. 2 is a flowchart 200 illustrating a method for scanning according to an embodiment.

At S210, data to be scanned is identified. The data to be scanned may be or may include data in a computing environment (for example, the computing environment 120, FIG. 1). Such data may be stored in one or more discs (for example, the disks 125), which may be physical disks, virtual disks, or a combination thereof.

At S220, scanning is initiated. In an embodiment, initiating the scanning includes running a command which returns outputs indicating folders, files, other objects, combinations thereof, and the like. As a non-limiting example, such a command may be a server message block (SMB) command which returns outputs indicating folders and files in a given computing environment. Such outputs may be parsed in order to identify files and folders within the computing environment. To this end, in an embodiment, initiating the scanning includes at least beginning such parsing.

The initial scanning may continue until a folder is encountered, for example, until parsing the outputs of the command yield a folder. In some embodiments, when a folder is encountered, scanning may pause when a folder is encountered until it is determined whether a duplicated folder is present, for example, whether the folder is or includes a duplicated folder.

At S230, a folder encountered during scanning is identified. As noted above, the folder may be a folder identified by parsing outputs of a command which returns data indicating folders and other objects within a computing environment.

At S240, one or more checks are performed to determine if the folder has or otherwise indicates the presence of a nested share. That is, the checks may be performed in order to determine if the folder is or includes a nested share.

In an embodiment, the duplicated folder checks use limited analyses which do not involve a full scan of data within folders. That is, such limited analyses are analyses which utilize fewer computing resources than a full scan. For example, such a scan may analyze only metadata such as folder and object names, but not scan the data within objects or otherwise scan the underlying data.

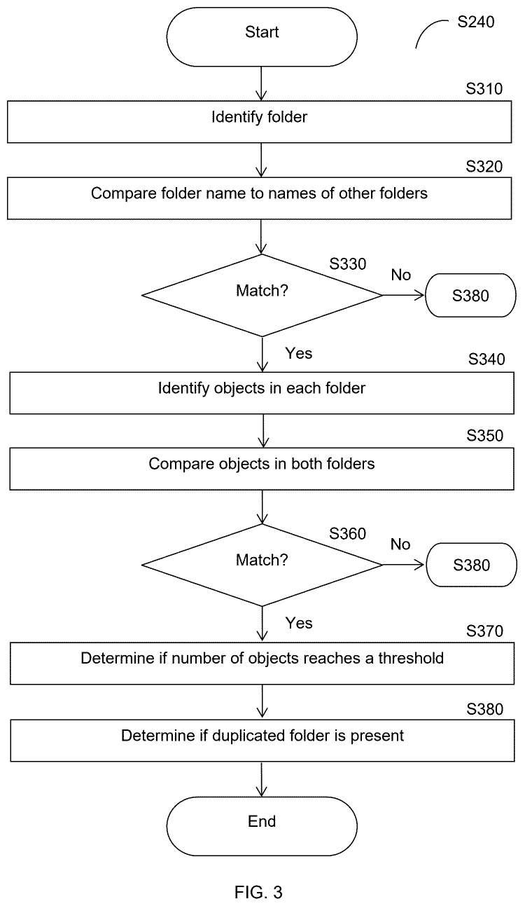

In an embodiment, a nested share is determined as present based on a name of the folder acting as a first folder matching a name of a second folder within the computing environment and the objects of the first folder matching objects of the second folder. In a further embodiment, the nested share is determined as present based further on the number of compared objects between the first folder and the second folder being above a threshold. An example process for performing duplicated folder checks which may be utilized at S240 is described further below with respect to FIG. 3.

At S250, based on the results of the checks, a folder is selected for scanning. In an embodiment, if a nested share is determined as being present for the folder (for example, the folder is or includes a nested share) based on name and object comparisons between that folder acting as a first folder with a second folder, then only one of the folders (i.e., only the first folder or the second folder) is scanned. That is, if it is determined that one of the folders is a duplicated folder of the other, then only one of the folders may be scanned, for example, to avoid redundant scanning. If it is determined that the folder is not indicative of the presence of a nested share, the folder may be scanned normally and scanning may continue normally until the next folder is encountered. That is, all folders may be scanned unless it is determined that a folder is or includes a duplicated folder, in which case only one of the duplicated folders or the parent folder of that duplicated folder may be scanned.

In an embodiment, selecting the folder to be scanned includes identifying one of the folders of a pair of folders as being a duplicated folder. More specifically, when the pair of folders is determined as including a duplicated folder, one of the folders of the pair is identified as the duplicated folder and the other folder may be identified as the parent folder of that duplicated folder. In a further embodiment, the identified duplicated folder is selected for scanning. In yet a further embodiment, only the identified duplicated folder is selected for scanning. That is, in such an embodiment, the parent folder is not scanned. As noted above, scanning only the duplicated folder may allow for avoiding redundant scanning (for example, scanning objects which are present in both the duplicated folder and the parent folder), reducing the total amount of scanning for the parent folder (for example, scanning only the duplicated folder may result in scanning a subset of objects of the parent folder), both, and the like.

In an embodiment, the parent folder is identified as an initial folder which was subjected to the checks as discussed herein with respect to S240 and FIG. 3, and the duplicated folder is identified as a folder withing the parent folder which was matched to the parent folder (for example, based on name comparison, object comparison, both, and the like). That is, the folder selected for performing the checks at S240 may be identified as a potential parent folder such that, when an inner folder of that potential parent folder is determined as matching the potential parent folder, the potential parent folder is identified as a parent folder of the matching folder and the matching inner folder is identified as a duplicated folder. As a non-limiting example, when a share is checked for potential nested shares and an inner folder inside of that share is determined to match the share, the checked share is identified as a parent share and the matching inner folder is identified as a nested share.

At S260, the selected folder is scanned. The folder may be scanned, for example, in order to analyze data within the folder, determine data types of data within the folder, and the like.

At S270, scanning of the computing environment resumes. In an embodiment, scanning resumes by resuming parsing of the outputs discussed above with respect to S220. Scanning may continue, for example, until the computing environment has been completely scanned (for example, until all applicable data within the computing environment has been scanned, excluding any folders skipped due to being parent folders of duplicated folders as described herein) or until a new folder is encountered (for example, when a new folder is encountered, the new folder may be checked for potential duplicated folders as described herein).

At S280, it is checked if more folders have been encountered since scanning resumed and, if so, execution may continue with S230 where a newly encountered folder is checked for potential duplicated folders; otherwise, scanning may conclude and execution terminates.

At optional S290, the results from scanning or otherwise results obtained during the scan are used. Using the results from the scanning may include, but is not limited to, securing data found during the scanning, deleting duplicate data, both, and the like.

In an embodiment, data found during scanning may be secured. In an embodiment, securing the data may include enforcing one or more policies defined with respect to storage of such data and controlling activities within a computing environment in order to secure the data. Such policies may define, for example but not limited to, permitted data storage conditions, forbidden data storage conditions, both, and the like. Such data storage conditions may be further defined with respect to data types, for example, such that different types of data have different permitted storage conditions or forbidden storage conditions. In another embodiment, securing the data may include removing or otherwise changing permissions for data (for example, changing permissions of one or more folders such as the duplicated folder).

In another embodiment, using results from the scanning includes using the results of the checks and, more specifically, identifications of duplicated folders, in order to delete duplicate data, thereby reducing the total amount of data and removing redundant data. Such deletion of duplicate data may also reduce the amount of computing resources used to maintain data in a computing environment, during subsequent scans of data in a computing environment, and the like. For example, when a duplicated folder is identified for a parent folder, the duplicated folder may be deleted. As a non-limiting example, when the duplicated folder is a nested share within a parent share, the nested share is deleted.

FIG. 3 is a flowchart S240 illustrating a method for avoiding duplicate scanning based on duplicated folders according to an embodiment.

At S310, a first folder to be checked is identified. The folder may be, for example but not limited to, a folder encountered during a scan of a computing environment.

At S320, folder names of inner folders within the first folder to be checked are compared to folder names of one or more second folders. As a non-limiting example, when the folders are indicated in outputs of a command executed on a computing environment, the name of each inner folder within the first folder may be compared to names of other folders which were previously found by parsing those outputs.

In some embodiments, folder names may not be compared at S320 and a different check may be performed instead. Alternatively, in some other embodiments, folder names may be compared but only require a certain threshold of matching in order to be determined as matching rather than requiring an exact match. In this regard, it is noted that names of duplicated folders may sometimes be changed such that requiring a name match may fail to identify at least some duplicated folders. In such cases, some duplicated folders may be found, but not necessarily all of them. Using alternative checks in addition to object-based checking as discussed below may allow for identifying duplicated folders accurately while identifying more potential duplicated folders than using name comparisons might yield in at least some implementations.

At S330, it is determined whether the folder name of any of the inner folders within the first folder matches any of the folder names of the second folders. If so, execution continues with S340. If not, execution continues with S380 where it is determined that no duplicated folder is present.

In this regard, identifying folders with matching folder names acts as a check of a first name-based checking phase. As noted above, duplicated folders created from parent folders often have the same name as their parent folders such that identifying folders with matching names may be utilized as a check to aid in identifying potential duplicated folders.

At S340, objects in an inner folder of the first folder and one of the second folders are identified. When the folder name of one of the inner folders of the first folder is determined to match one of the second folders, the objects in the name-matching second folder for a given inner folder are compared to the objects of that inner folder.

In an embodiment, identifying the objects in each folder includes running a list command on the objects in the folder in order to obtain a list of objects in the folder. This list may be compared to the list of objects of the other folder in order to determine if the objects in the folders match as discussed below.

At S350, objects are compared between one of the inner folders of the first folder and one of the second folders. In an embodiment, objects of a first inner folder of the first folder are compared to objects of a name-matching second folder whose name matches the name of the first inner folder.

The objects may be or may include, but are not limited to, files. In an embodiment, comparing objects between the folders includes comparing lists of objects in each folder, for example, lists created by running a list command on each folder. The comparison is performed to determine if the objects in the folders match. If there are any mismatches (for example, one or more objects which are included in the list of one folder but not in another), then the folders may be determined as not including a duplicated folder between them.

More specifically, the first folder is determined as containing one or more inner folders, and the second folder may be a suspected or otherwise candidate for one of the inner folders of the first folder (for example, a name-matching folder whose name matches a name of an inner folder of the first folder). That is, the second folder is suspected as being an inner folder of the first folder based on, for example, name matching between the second folder and a first inner folder whose name matches the name-matching second folder where the first inner folder is within the first folder.

At S360, it is determined if the compared objects match. If so, execution continues with S370. If not, execution continues with S380 where it is determined that no duplicated folder is present.

At optional S370, it is determined if a number of objects compared between the first inner folder and the name-matching second folder reaches a threshold. If the number of compared objects is above the threshold, it may be determined that a duplicated folder is present; otherwise, it may be determined that a duplicated folder is not present. In an embodiment, S370 includes determining whether a total number of objects which have been compared between the first inner folder and the name-matching second folder is at or above the threshold and, if so, it may be determined that the threshold has been reached.

In some embodiments (not depicted in FIG. 3), the objects may be compared between the folders recursively until either all potential recursions have been iterated or until the threshold has been reached. That is, if it is determined that the number of objects compared between the folders has not reached the threshold, each folder may be further analyzed (for example, at a next level within the folder) for more objects, and the additional objects may be compared. To this end, in such embodiments, when it is determined that the total number of objects compared between folders has not reached the threshold, each folder may be further analyzed to determine if there are more objects in the folder and, if both folders have more objects, additional objects may be compared and it may be determined whether the total number of compared objects has reached the threshold. This may continue until all objects in either or both folders have been exhausted.

For example, objects at a first level within each folder such as all of the subfolders directly below the folder in a folder hierarchy may be compared to objects in the first level of the other folder. If the objects compared at the first level match but do not meet the threshold number of objects needed to increase confidence that the match effectively represents the presence of a duplicated folder, then recursion may continue with comparing objects at a next level of each folder (for example, second, then third, then fourth, etc.) until either the total number of objects compared achieves the threshold or objects from all potential levels for either or both of the folders have been compared. As a non-limiting example, a level 1 dir command may be executed on each folder in order to obtain a list of first level objects at a first level of each folder, and the first level objects may be compared. If the first level objects match between folders but the number of comparisons is below a threshold (for example, 5 object comparisons), then a level 2 dir command may be executed on each folder to identify second level objects of each folder, and the second level objects may be compared between folders. At the second iteration, if the total number of comparisons of first level objects and of second level objects meets the threshold number, then it may be determined that the threshold has been reached.

This recursive comparison may allow for further improving efficiency of the checks. That is, folders may be recursively analyzed deeper only as necessary to see if additional objects might be available when the threshold has not been reached by analyzing the folders in levels or otherwise analyzing in stages. As a result, at least some of the pairs of folders may be determined as having a duplicated folder without needing to identify each and every object in the folders of the pair.

At S380, it is determined whether a duplicated folder is present based on any or all of the checks at S330, S360, and S370. That is, for a given pair of folders including a first folder and a second folder, it is determined whether one of the folders is a duplicated folder of the other folder such that the other folder is a parent folder of the duplicated folder. As noted above, identifying a nested share may allow for avoiding redundant scanning or otherwise reducing the total amount of data to be scanned.

In an embodiment, a nested share is determined as present based on a name of a first folder matching a name of a second folder and the objects of the first folder which were compared to the objects of the second folder matching. For example, a nested share may be determined as being present when a pair of folders including a first folder and a second folder have matching names and the objects compared between the first and second folders match.

In a further embodiment, the nested share is determined as present based further on the number of compared objects between the first folder and the second folder being above a threshold. For example, a nested share may be determined as being present when a pair of folders including a first folder and a second folder have matching names, the objects compared between the first and second folders match, and the number of objects compared between the first and second folders is above a threshold.

It should be noted that various embodiments are discussed with respect to comparing objects between an inner folder and a name-matching second folder, but that in some embodiments, no name matching may be performed such that the comparison of objects is between a first inner folder and one of the second folders whose name may or may not match that of the first inner folder.

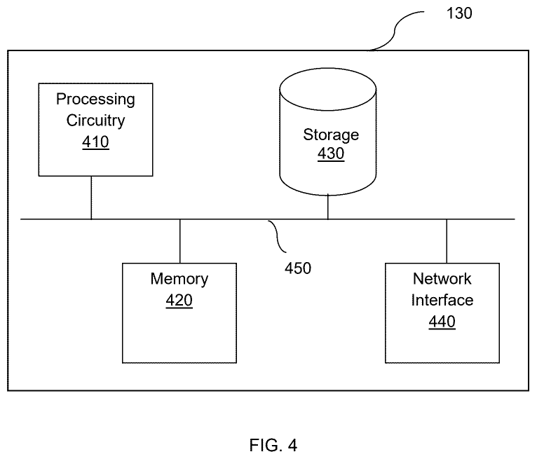

FIG. 4 is an example schematic diagram of a scanner 130 according to an embodiment. The scanner 130 includes a processing circuitry 410 coupled to a memory 420, a storage 430, and a network interface 440. In an embodiment, the components of the scanner 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In at least some embodiments, the processing circuitry 410 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 410 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 410 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds of activities), networking and connectivity (e.g., in order to support seamless data transfer for deployments involving communications between or among multiple machines or clusters), combinations thereof, and the like.

In embodiments which utilize large language models (LLMs) or otherwise perform operations which may require or be enhanced through use of parallel processing, the processing circuitry 410 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors for use in computing attention weights. In at least some such embodiments using GPUs, the processing circuitry 410 may include a number of CPU cores which is equal to or greater than the number of GPUs in order to facilitate or otherwise support parallel processing via multiple GPUs.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the scanner 130 to communicate with other systems, devices, components, applications, or other hardware or software components, for example as described herein.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for scanning, comprising:
scanning at least one computing environment until a first folder is identified, wherein scanning the at least one computing environment includes running a command which returns outputs indicating a plurality of objects and parsing the plurality of objects in order to identify the first folder, wherein the scanning is paused when the first folder is identified;
comparing, in a name comparison, a name of at least one inner folder within the first folder to a plurality of names of a plurality of second folders in order to identify a name-matching second folder of the plurality of second folders, wherein the name of the matching second folder matches the name of a first inner folder of the at least one inner folder within the first folder;
identifying a plurality of objects of the at least one inner folder and a plurality of objects of the name-matching second folder when the name of the matching second folder is determined to match the name of the first inner folder;
comparing, in an object comparison, the identified plurality of objects of the first inner folder within the first folder to the identified plurality of objects of the name-matching second folder in order to determine that the plurality of objects of the first inner folder match the plurality of objects of the name-matching second folder;
identifying a duplicated folder based on the name comparison and the object comparison;
scanning only one of the first folder and the name-matching second folder when the duplicated folder is identified, wherein the scanning further comprises running a command via processing circuitry of a scanner; and
resuming scanning of the at least one computing environment when the only one of the first folder and the name-matching second folder has been scanned.

2. The method of claim 1, further comprising:
determining that a number of comparisons between the plurality of objects of the first inner folder and the plurality of objects of the name-matching second folder reaches a threshold, wherein the duplicated folder is identified based further on the determination that the number of comparisons between the plurality of objects of the first inner folder and the plurality of objects of the name-matching second folder reaches the threshold.

3. The method of claim 2, wherein comparing the plurality of objects of the first inner folder to the plurality of objects of the name-matching second folder further comprises:
recursively identifying objects among the plurality of objects of the first inner folder and among the plurality of objects of the name-matching second folder and comparing the recursively identified objects between the first inner folder and the name-matching second folder until a total number of comparisons of objects between the first inner folder and the name-matching second folder reaches the threshold, wherein it is determined that the number of comparisons between the plurality of objects of the first inner folder and the plurality of objects of the name-matching second folder reaches the threshold when the total number of comparisons between the first inner folder and the name-matching second folder reaches the threshold.

4. The method of claim 1, wherein the object comparison further comprises:
running a listing command on each of the first inner folder and the name-matching second folder, wherein the listing command run on a folder returns a list of objects of the folder, wherein the plurality of objects of the first inner folder is based on results of running the listing command on the first inner folder, wherein the plurality of objects of the name-matching second folder is based on results of running the listing command on the name-matching second folder.

5. (canceled)

6. The method of claim 1, wherein the plurality of objects of the first inner folder and the plurality of objects of the name-matching second folder include files.

7. The method of claim 1, wherein the object comparison is performed when the name-matching second folder has been identified based on the name comparison.

8. The method of claim 1, wherein the duplicated folder is identified as the name-matching second folder, wherein the name-matching second folder resides in the first folder.

9. The method of claim 1, wherein the first folder and each of the plurality of second folders is a shared folder, wherein the identified duplicated folder is a nested share which resides in the first folder.

10. A non-transitory computer-readable medium having stored thereon instructions for causing a processing circuitry to execute a process, the process comprising:
scanning at least one computing environment until a first folder is identified, wherein scanning the at least one computing environment includes running a command which returns outputs indicating a plurality of objects and parsing the plurality of objects in order to identify the first folder, wherein the scanning is paused when the first folder is identified;
comparing, in a name comparison, a name of at least one inner folder within the first folder to a plurality of names of a plurality of second folders in order to identify a name-matching second folder of the plurality of second folders, wherein the name of the matching second folder matches the name of a first inner folder of the at least one inner folder within the first folder;
identifying a plurality of objects of the at least one inner folder and a plurality of objects of the name-matching second folder when the name of the matching second folder is determined to match the name of the first inner folder;
comparing, in an object comparison, the identified plurality of objects of the first inner folder within the first folder to the identified plurality of objects of the name-matching second folder in order to determine that the plurality of objects of the first inner folder match the plurality of objects of the name-matching second folder;
identifying a duplicated folder based on the name comparison and the object comparison;
scanning only one of the first folder and the name-matching second folder when the duplicated folder is identified, wherein the scanning further comprises running a command via processing circuitry of a scanner; and
resuming scanning of the at least one computing environment when the only one of the first folder and the name-matching second folder has been scanned.

11. A system for scanning, comprising:
a processing circuitry; and
a memory, the memory containing instructions that, when executed by the processing circuitry, configure the system to:
scan at least one computing environment until a first folder is identified, wherein the processing circuitry is further configured to run a command which returns outputs indicating a plurality of objects and to parse the plurality of objects in order to identify the first folder, wherein the scanning is paused when the first folder is identified;
compare, in a name comparison, a name of at least one inner folder within a first folder to a plurality of names of a plurality of second folders in order to identify a name-matching second folder of the plurality of second folders, wherein the name of the matching second folder matches the name of a first inner folder of the at least one inner folder within the first folder;
identify a plurality of objects of the at least one inner folder and a plurality of objects of the name-matching second folder when the name of the matching second folder is determined to match the name of the first inner folder;
compare, in an object comparison, the identified plurality of objects of the first inner folder within the first folder to the identified plurality of objects of the name-matching second folder in order to determine that the plurality of objects of the first inner folder match the plurality of objects of the name-matching second folder;
of objects of the name-matching second folder in order to determine that the plurality of objects of the first inner folder match the plurality of objects of the name-matching second folder;
identify a duplicated folder based on the name comparison and the object comparison;
scan only one of the first folder and the name-matching second folder when the duplicated folder is identified; and
resume scanning of the at least one computing environment when the only one of the first folder and the name-matching second folder has been scanned.

12. The system of claim 11, wherein the system is further configured to:
determine that a number of comparisons between the plurality of objects of the first inner folder and the plurality of objects of the name-matching second folder reaches a threshold, wherein the duplicated folder is identified based further on the determination that the number of comparisons between the plurality of objects of the first inner folder and the plurality of objects of the name-matching second folder reaches the threshold.

13. The system of claim 12, wherein the system is further configured to:
recursively identify objects among the plurality of objects of the first inner folder and among the plurality of objects of the name-matching second folder and comparing the recursively identified objects between the first inner folder and the name-matching second folder until a total number of comparisons of objects between the first inner folder and the name-matching second folder reaches the threshold, wherein it is determined that the number of comparisons between the plurality of objects of the first inner folder and the plurality of objects of the name-matching second folder reaches the threshold when the total number of comparisons between the first inner folder and the name-matching second folder reaches the threshold.

14. The system of claim 11, wherein the system is further configured to:
run a listing command on each of the first inner folder and the name-matching second folder, wherein the listing command run on a folder returns a list of objects of the folder, wherein the plurality of objects of the first inner folder is based on results of running the listing command on the first inner folder, wherein the plurality of objects of the name-matching second folder is based on results of running the listing command on the name-matching second folder.

15. (canceled)

16. The system of claim 11, wherein the plurality of objects of the first inner folder and the plurality of objects of the name-matching second folder include files.

17. The system of claim 11, wherein the object comparison is performed when the name-matching second folder has been identified based on the name comparison.

18. The system of claim 11, wherein the duplicated folder is identified as the name-matching second folder, wherein the name-matching second folder resides in the first folder.

19. The system of claim 11, wherein the first folder and each of the plurality of second folders is a shared folder, wherein the identified duplicated folder is a nested share which resides in the first folder.
